(19) United States
(12) Patent Application Publication
(10) Pub. No.: US 2023/0275426 A1
(43) Pub. Date: Aug. 31, 2023

(54) DC POWER DISTRIBUTION SYSTEM, CONTROL APPARATUS, OPERATING STATE DETERMINATION METHOD AND PROGRAM

(71) Applicant: NIPPON TELEGRAPH AND TELEPHONE CORPORATION, Tokyo (JP)

(72) Inventors: Naoki HANAOKA, Tokyo (JP); Hidetoshi TAKADA, Tokyo (JP); Toshimitsu TANAKA, Tokyo (JP); Naomichi NAKAMURA, Tokyo (JP)

(21) Appl. No.: 18/040,864

(22) PCT Filed: Aug. 21, 2020
(86) PCT No.: PCT/JP2020/031729

§ 371 Date: Feb. 7, 2023

(51) Int. Cl. H02J 1/00; G05B 19/042

(52) U.S. Cl. CPC H02J 1/00; G05B 19/042; G05B 2219/2639

(57) ABSTRACT

A direct-current power distribution system for distributing power from a power supply device to a load device via a power distribution network includes a measuring instrument included in the power distribution network, and a control device including a determination unit configured to acquire a voltage value and a current value measured by the measuring instrument, and determine an operating state in the direct-current power distribution system on the basis of a waveform indicating change in the voltage value and a waveform indicating change in the current value.

### TECHNICAL FIELD

The present invention relates to a technology for detecting an accident such as a ground fault or a short circuit that has occurred in a power distribution system.

### BACKGROUND ART

In a power distribution system, it is necessary to take measures such as stopping power distribution from a power supply device when an accident such as a ground fault or a short circuit is detected.

As an example of a device for detecting an accident such as a ground fault or a short circuit, a distance relay (Example: a mho relay described in NPL 1) is used in, for example, a transmission end of an alternating current substation. The distance relay operates when a function of a ratio of a voltage to a current becomes a predetermined value or less with a voltage and a current as input amounts. This ratio is referred to as impedance from the perspective of the distance relay.

Incidentally, in a communication building, a data center, or the like, a high-voltage direct-current power distribution system is introduced to reduce power loss of an entire system and achieve energy saving. In the high-voltage direct-current power distribution system, power distribution is performed with a high voltage such as 380 V.

### CITATION LIST

### Non Patent Literature

[NPL 1] Glossary (22nd Theme: MHO Relay), IEEJ Transactions on Electricity and Energy, Vol. 132 (2012) No. 8, https://www.jstage.jst.go.jp/article/ieejpes/132/8/132_NL8_6/_pdf

### SUMMARY OF INVENTION

### Technical Problem

Because the direct current used in the high-voltage direct-current power distribution system does not have a reactance component, a distance relay such as the mho relay described in NPL 1 cannot be used. Further, there is no distance relay for direct-current distribution of a high voltage such as 380 V on the market.

Although there is related art for detecting an accident such as a ground fault or a short circuit that has occurred in a direct-current power distribution system, accuracy of detection is not sufficient, for example, an event that is not an accident is erroneously detected as an accident.

An object of the present invention is to provide a technology capable of accurately detecting an accident that occurs in a direct-current power distribution system.

### Solution to Problem

A direct-current power distribution system for distributing power from a power supply device to a load device via a power distribution network, the direct-current power distribution system including:
a measuring instrument included in the power distribution network; and
a control device including a determination unit configured to acquire a voltage value and a current value measured by the measuring instrument, and determine an operating state in the direct-current power distribution system on the basis of a waveform indicating change in the voltage value and a waveform indicating change in the current value.

### Advantageous Effects of Invention

According to the disclosed technology, it is possible to accurately detect an accident that has occurred in a direct-current power distribution system.

### BRIEF DESCRIPTION OF DRAWINGS

FIG. 1 is a diagram illustrating configuration example 1 of a direct-current accident detection system according to an embodiment of the present invention.

FIG. 2 is a diagram illustrating an example of a detection value and a determination result.

FIG. 3 is a diagram illustrating a configuration example 2 of the direct-current accident detection system according to the embodiment of the present invention.

FIG. 4 is a diagram illustrating a configuration example of a control device.

FIG. 5 is a diagram illustrating a configuration example of a control device.

FIG. 6 is a diagram illustrating a configuration example of a learning device.

FIG. 7 is a diagram illustrating a hardware configuration example of the device.

FIG. 8 is a flowchart illustrating an operation of the control device.

FIG. 9 is a flowchart illustrating the operation of the control device.

FIG. 10 is a diagram illustrating an example of a waveform.

FIG. 11 is a diagram illustrating an example of a waveform.

### DESCRIPTION OF EMBODIMENTS

Hereinafter, an embodiment of the present invention (the present embodiment) will be described with reference to the drawings. The embodiment to be described hereinafter is merely an example, and embodiments to which the present invention is applied are not limited to the following embodiment.

The direct-current power distribution system in the present embodiment is assumed to be a high-voltage direct-current power distribution system (hereinafter referred to as a direct-current power distribution system) that performs power distribution with a direct current of 380 V. However, “380 V” is an example. Further, the present invention is applicable not only to a high-voltage direct-current power distribution system but also to an entire direct-current power distribution system.

### System Configuration Example 1

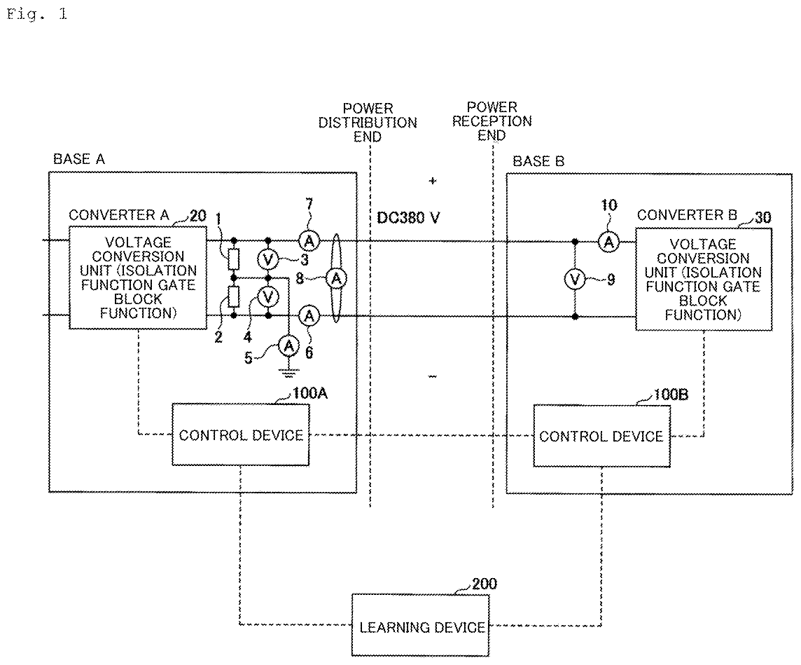

FIG. 1 illustrates a configuration example 1 of a direct-current power distribution system according to the present embodiment. Configuration example 1 shows a system that performs distribution of power by direct current from a base A to a base B. The base A and the base B are, for example, buildings such as communication buildings, but are not limited to buildings.

In configuration example 1, a converter A 20 is included in the base A, and a converter B 30 is included in the base B. Each of the converters is a DC/DC converter, which is a device that converts a magnitude of a direct current voltage. The converter A 20 may be an AC/DC converter. As illustrated, each converter includes a voltage conversion unit, and has an insulation function and a gate block function.

The converter A 20 in the base A and the converter B 30 in the base B are connected by a power distribution network (a positive side power distribution line and a negative side power distribution line), and a DC current of 380 V is distributed from the converter A 20 in the base A to the converter B 30 in the base B. The converter B 30 is an example of a load device that receives the distributed power. Further, in the base B, one or more load devices (a server and the like) are connected under the converter B 30. The “load device” includes the converter B 30, and a device such as a server supplied with power from the converter B 30. Further, the “direct-current power distribution system” includes the converter A 20, the power distribution network, and the load device.

The converter A 20 is an example of a power supply device capable of supplying a sufficient current to an accident point when an accident (for example, ground fault, short circuit, or partial short circuit) occurs in the power distribution network (including a power network in a load device that receives supplied power).

Further, a control device 100A is included in the base A, and a control device 100B is included in the base B. The control device 100A and the control device 100B are connected by a communication network.

The control device 100A may be a device inside the converter A 20 or may be a device outside the converter A 20. Further, the control device 100A may be included outside the base A. The control device 100B may be a device inside the converter B 30 or may be a device outside the converter B 30. Further, the control device 100B may be included outside the base B. Further, one control device may be included for a plurality of bases instead of a control device being included for each base.

As illustrated in FIG. 1, a learning device 200 is included. The learning device 200 may be installed anywhere, and for example, a virtual machine on a cloud may be used as the learning device 200. The learning device 200 is connected to the control device 100A and the control device 100B via the communication network. The control device 100A or the control device 100B may function as the learning device 200.

In the direct-current power distribution system of the present embodiment, a neutral point grounding configuration using high resistance is used in the base A. Specifically, as illustrated in FIG. 1, between an output portion of the converter A 20 and a power distribution end (a boundary portion between the inside and the outside of the base A), a resistor 1 and a resistor 2 are included between the positive side power distribution line and the negative side power distribution line, and a neutral point therebetween is grounded to the ground (earth). Both the resistor 1 and the resistor 2 have, for example, a high resistance of several M. The neutral point grounding configuration using high resistance may be included inside the converter A 20.

As illustrated in FIG. 1, in the base A, a voltmeter 3 is included between the positive side power distribution line (+) and the neutral point, a voltmeter 4 is included between the negative side power distribution line (−) and the neutral point, and an ammeter 5 is included between the neutral point and a ground point.

Further, ammeters 6 and 7 are included in the negative side power distribution line and the positive side power distribution line. Further, a zero-phase current transformer 8 (ZCT) is included. The zero-phase current transformer 8 measures and outputs a current value generated due to unbalance when a reciprocating current in the positive side power distribution line and the negative side power distribution line is unbalanced.

Further, in the base B, between a power reception end (a boundary portion between the outside and the inside of the base B) and the converter B 30, a voltmeter 9 is included between the positive side power distribution line and the negative side power distribution line, and an ammeter 10 is included in the positive side power distribution line.

A method of deploying the measuring instruments such as the ammeters and the voltmeters illustrated in FIG. 1 is an example. More measuring instruments may be deployed or fewer measuring instruments may be deployed compared to the deployment method illustrated in FIG. 1. For example, the measuring instruments may not be deployed on the base B side.

### Overview of Operation

In the base A, each measuring instrument performs measurement at short time intervals (for example, in units of several us to several ms), and the control device 100A acquires the measurement result obtained by each measuring instrument. Similarly, in the base B, each measuring instrument performs measurement at short time intervals (for example, measurement in units of several us to several ms), and the control device 100B acquires a measurement result obtained by each measuring instrument.

Although both the control device 100A and the control device 1002 can perform a determination as to an operating state (an event other than an accident such as an accident or load fluctuation) in the direct-current power distribution system, it is assumed in the present embodiment that the control device 100A performs the determination.

When the control device 100A performs the determination as to the operating state, the control device 100B transmits a measurement result obtained by each measuring instrument in the base B to the control device 100A via the communication network. Further, the control device 100B also monitors a state of the load device at short time intervals (for example, measurement in units of several us to several ms), and transmits information (device information) on the state of the load device acquired by the monitoring to the control device 100A.

The control device 100A determines an operating state such as a ground fault (+ side), a ground fault (− side), a short circuit, a partial short circuit, an inrush current, load connection, load ON and load OFF, and load fluctuation from any one or more (including all) of the voltage value, the current value, the waveform indicating the change in the voltage value, the waveform indicating the change in the current value, and the device information, on the basis of the respective measurement results and the device information acquired in the base A and the base B.

The short circuit means that the positive side power distribution line and the negative side power distribution line are connected with a small resistance, and the partial short circuit means that the positive side power distribution line and the negative side power distribution line are connected with a large resistance.

The control device 100A displays a determination result. The control device 100A transmits the determination result to the control device 100B, so that the control device B can also display the determination result.

Further, when the control device 100A detects an accident such as a ground fault or a short circuit, the control device 100A can transmit an abnormality signal to the converter A 20 to operate a gate block in the converter A 20 and stop the power distribution. Further, when the control device 100A detects an accident such as a ground fault or a short circuit, the control device 100A can transmit the determination result or an abnormality signal to the control device 100B so that the control signal 100B operates, for example, the gate block in the base B.

Further, because the control device 100A can discriminate an event such as an inrush current or a load connection that is not an accident from the waveform indicating the change in current value or the voltage value, it is possible to prevent a malfunction such as erroneously stopping the power distribution.

### Example of Determination Result

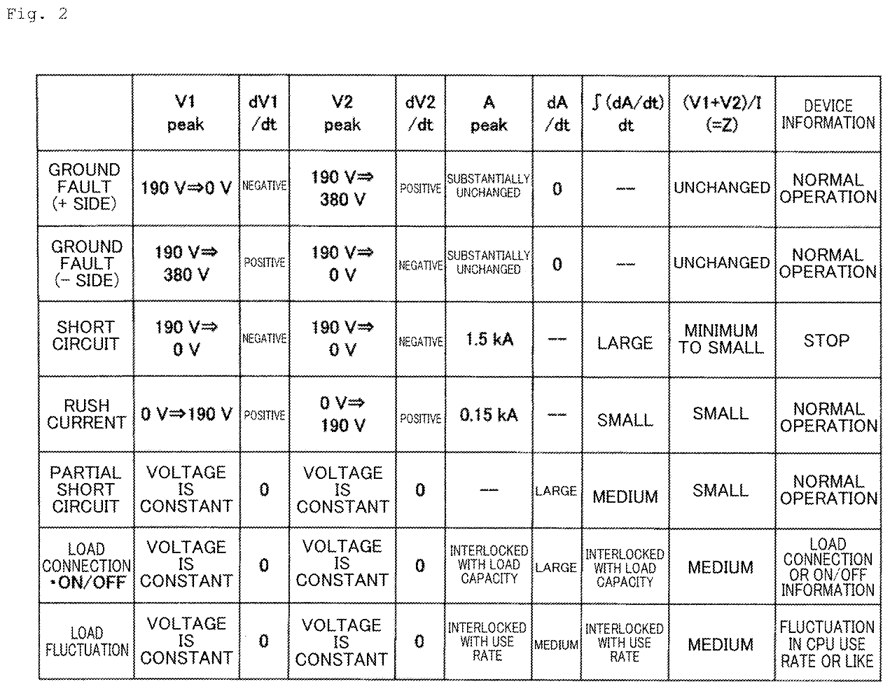

FIG. 2 illustrates an example of a detection value and a determination result of the measuring instrument. In FIG. 2, V1 indicates a detection value of the voltmeter 3 between the neutral point and the positive side power distribution line, and V2 indicates a detection value of the voltmeter 4 between the neutral point and the negative side power distribution line. A indicates, for example, a detection value (current value) of the ammeter 7 or the ammeter 6. “peak” means a maximum value (a maximum value among values that fluctuate in a short time).

dV1/dt indicates a derivative of V1 with respect to time t and indicates a temporal change in V1. The same applies to dV2/dt and dA/dt. ∫(dA/dt)dt indicates an integral of an amount of change in A.

I in (V1+V2)/I is, for example, a detection value (current value) of the ammeter 7 or the ammeter 6. Impedance Z (may be referred to as “resistance” when only a direct current is considered) is obtained by (V1+V2)/I.

For example, when an accident such as a short circuit has occurred in the power distribution network between the base A and the base B, the control device 100A can calculate impedance of the power distribution line between the base A (specifically, the measuring instrument) and the accident point using (V1+V2)/I, and calculate a distance between the base A and the accident point. That is, the control device 100A can calculate the distance by dividing the impedance obtained by (V1+V2)/I by impedance per unit length of the power distribution line between the base A and the accident point.

The impedance per unit length of the power distribution line is determined by a thickness (cross section) of the power distribution line. Further, in general, because the thickness of the power distribution line (that is, the impedance per unit length of the power distribution line) is determined by a scale of the power distribution network (power distribution between bases, power distribution within a base, or the like), the control device 100A holds the impedance per unit length of the power distribution line in a storage unit for each scale of the power distribution network in advance, and calculates the distance using the impedance per unit length suitable for the scale of the power distribution network that is a control target. Further, the control device 100A may derive an impedance including a component of jX (reactance) when a transient phenomenon of a current or voltage is captured.

FIG. 2, for example, shows that it can be determined that a ground fault has occurred in the positive side power distribution line when a measurement result corresponding to a voltage waveform in which V1 suddenly becomes 0 and V2 suddenly becomes 380 V is obtained. Other events are also as illustrated in FIG. 2. A more specific determination logic (flow) will be described below.

Each of the control device 100A and the control device 100B may transmit the acquired measurement result or the like to the learning device 200, and the learning device 200 may learn a relationship between the waveform and the event from any one or both of the waveform of the voltage value and waveform of the current value.

A scheme for the learning is not limited to a specific method, but for example, a model of a neural network may be used. As an example, an example of learning of an inrush current will be described. First, a large number of waveforms obtained from the measurement result of the ammeter when the inrush current has been generated in the power distribution network are acquired as learning data.

The learning device 200 inputs a waveform of the learning data to the model, and learns parameters of the model so that a classification of the waveform becomes an “inrush current”. The learned model is stored in the control device 100A. The control device 100A can discriminate whether or not the waveform of the measurement result corresponds to the inrush current by using the model.

Similarly, it is possible to discriminate each of events such as the ground fault (+ side), the ground fault (− side), the short circuit, the partial short circuit, the load connection, the load ON (load application) and load OFF, and the load fluctuation, by using the model.

Performing a discrimination of an event (operating state) using the model of the neural network as described above is an example.

For example, for each event, a representative waveform observed when the event has occurred is prepared as a representative waveform and stored in the storage unit of the control device 100A. The control device 100A can compare a detected waveform with the representative waveform of each event to determine that an event having the representative waveform close to the detected waveform has occurred. In the comparison between the detected waveform and the representative waveform of each event, for example, any one or more (including all) of a plurality of feature quantities (for example, an inclination, a time length from start of change to end of the change, and a magnitude of the change (a difference between a value before change and a value after change)) may be compared between the observed waveform and the representative waveform, and it may be determined whether or not the detected waveform is close to the representative waveform depending on whether a difference in each feature quantity is smaller than a threshold value.

### System Configuration Example 2

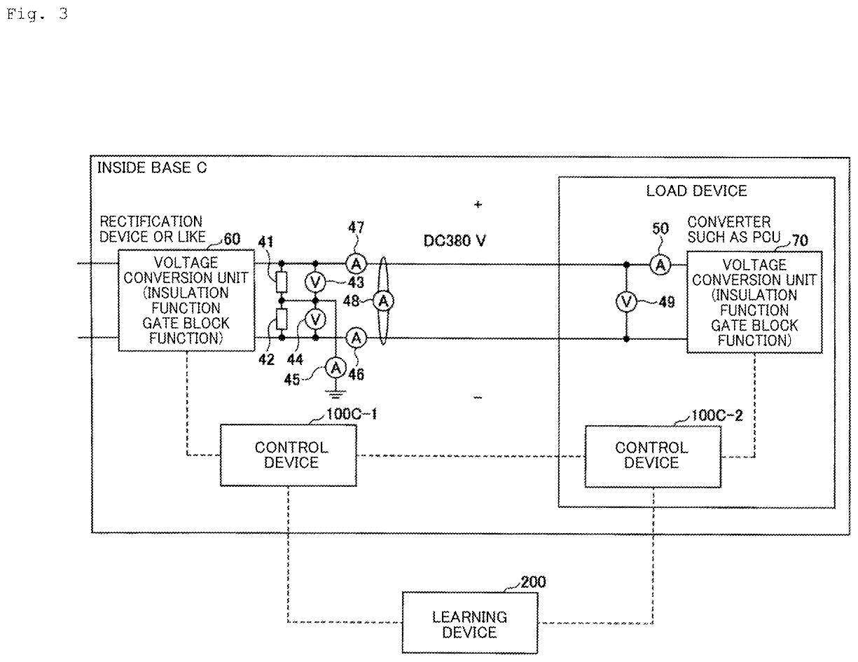

FIG. 3 illustrates configuration example 2 of the direct-current power distribution system according to the present embodiment. Configuration example 2 shows a system that performs power distribution (power supply) from a power supply device such as a rectification device 60 to a load device 80 inside a base C. The base C is, for example, a building such as a communication building, but is not limited to the building.

Configuration example 2 differs in scale from configuration example 1, and a basic configuration is the same in configuration example 1 and configuration example 2.

The rectification device 60 converts alternating current from a commercial power supply into direct current and outputs direct current power. The rectification device 60 includes a voltage conversion unit and has an insulation function and a gate block function, similar to the converter A 20 of configuration example 1. The load device 80 is, for example, a device such as a server, and a converter 70 exists inside the load device. The converter 70 includes a voltage conversion unit, and has an insulation function and a gate block function. Further, the rectification device 60 has a high resistance neutral point grounding configuration as in configuration example 1, and measuring instruments such as a voltmeter, an ammeter, and a zero-phase current transformer are included.

Further, a control device 100C-1, a control device 100C-2, and a learning device 200 are included, similar to the control device 100A, the control device 100B, and the learning device 200 in configuration example 1. Here, the control device 100C-2 is a functional unit inside the load device 80. An operation in configuration example 2 is the same as the operation in configuration example 1.

### Configuration Example of Control Device 100

As an example, a configuration example of the control device 100A and the control device 100B in the direct-current power distribution system illustrated in FIG. 1 will be described. Here, as an example, it is assumed that the control device 100A performs the determination processing and the control device 100B does not perform the determination processing.

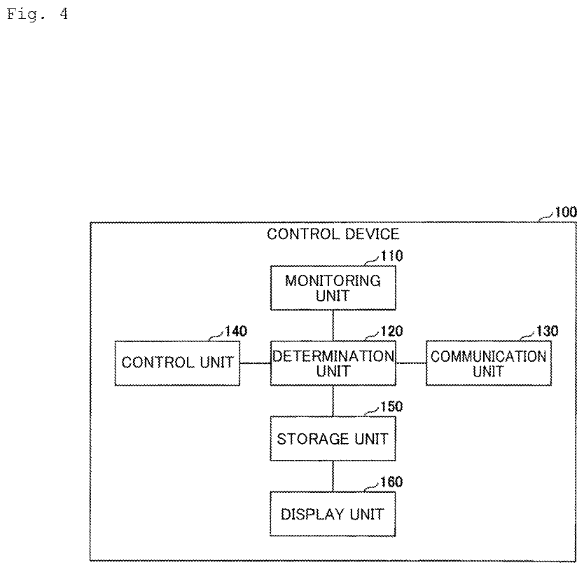

FIG. 4 illustrates a configuration example of the control device 100A. As illustrated in FIG. 4, the control device 100A includes a monitoring unit 110, a determination unit 120, a communication unit 130, a control unit 140, a storage unit 150, and a display unit 160.

The monitoring unit 110 acquires the measurement results obtained by the measuring instruments (the voltmeter, the ammeter, and the like) in the base A, and inputs the acquired measurement results to the determination unit 120. Further, the monitoring unit 110 can also acquire device information (for example, information of the converter A 20) in the base A.

The communication unit 130 communicates with another control device 100 or the learning device 200. More specifically, the communication unit 130 receives the measurement result and the device information from the control device 100B in the base B, and inputs these to the determination unit 120.

The determination unit 120 determines an operating state such as the ground fault (+ side), the ground fault (− side), the short circuit, the partial short circuit, the inrush current, the load connection, the load ON and load OFF, and the load fluctuation on the basis of the measurement result input from the monitoring unit 110 and the information input from the communication unit 130.

A threshold value required for the determination, for example, is stored in the storage unit 150. Further, when the determination is performed using the above-described model, the model (specifically, learned parameters) is stored in the storage unit 150, and the determination unit 120 reads the model from the storage unit 150 and uses the model for the determination.

Further, the determination unit 120 may store a determination result for an operating state such as the ground fault (+ side), the ground fault (− side), the short circuit, the partial short circuit, the inrush current, the load connection, the load ON and load OFF, and the load fluctuation, and the waveform of the voltage value, the waveform of the current value, or both the waveform of the voltage value and the waveform of the current value corresponding to the determination result in the storage unit 150. The stored data (data of a set of determination result and the waveforms) can be used as learning data in the learning device 200. The control device 100A may include a learning function without including the learning device 200.

The control unit 140 transmits an abnormality signal for operating the gate block to the converter A 20 when the determination result indicates the accident such as a ground fault or a short circuit. The display unit 160 displays the determination result or the like.

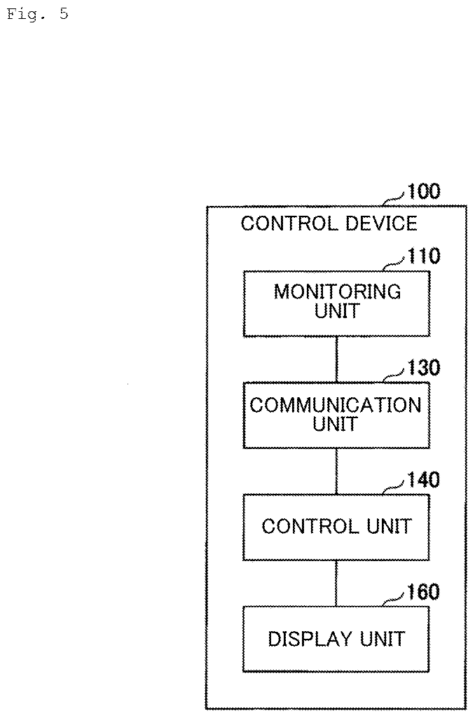

FIG. 5 is a diagram illustrating a configuration example of the control device 100B in the base B. As illustrated in FIG. 5, the control device 100B includes the monitoring unit 110, the communication unit 130, the control unit 140, and the display unit 160.

The monitoring unit 110 acquires the measurement result measured by each measuring instrument in the base B, and also acquires the device information of the load device in the base B. The communication unit 130 transmits the measurement result and the device information acquired by the monitoring unit 110 to the control device 100A in the base A.

The determination processing is executed in the control device 100A, and the determination result is transmitted to the control device 100B in the base B. For example, when the determination result indicates the occurrence of an accident, the control unit 140 outputs the abnormality signal for operating the gate block of the base B. Further, the display unit 160 outputs information indicating that an accident has occurred. Alternatively, the abnormality signal may be transmitted from the control device 100A to the control device 100B in the base B.

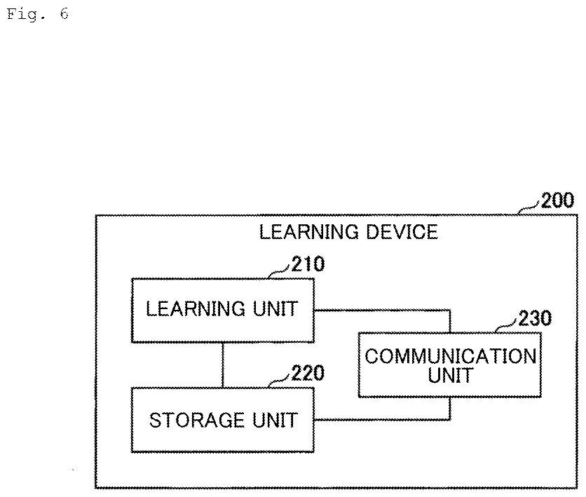

FIG. 6 is a diagram illustrating a configuration example of the learning device 200. As illustrated in FIG. 6, the learning device 200 includes a learning unit 210, a storage unit 220, and a communication unit 230. The communication unit 230 receives learning data (for example, data of a set of an event and a waveform) from, for example, the control devices 100A and 100B, and stores the learning data in the storage unit 220. The learning unit 210 performs learning using the learning data. For example, as described above, the learning unit 210 performs learning of the model of the neural network. The communication unit 230 transmits the learned model to the control device 100A or the like.

### Hardware Configuration Example

The control devices 100A, 100B, 100C-1, and 100C-2, and the learning device 200 can all be realized by, for example, causing a computer to execute a program. This computer may be a physical computer or may be a virtual machine.

That is, the device (the control devices 100A, 100B, 100C-1, and 100C-2, and the learning device 200) can be realized by executing a program corresponding to processing that is performed by the device, using hardware resources such as a CPU and memory built into the computer. The program can be recorded on a computer-readable recording medium (a portable memory or the like), stored, and distributed. It is also possible to provide the program through a network such as the Internet or e-mail.

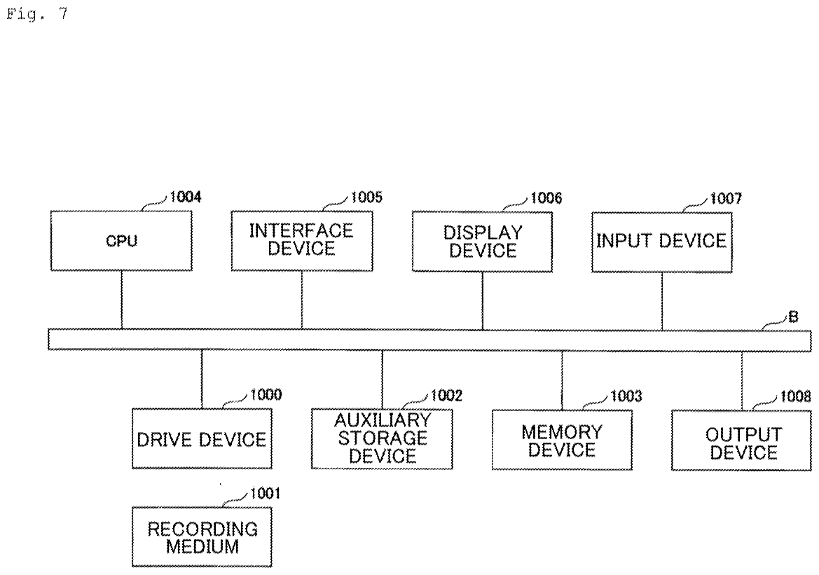

FIG. 7 is a diagram illustrating a hardware configuration example of the computer. The computer of FIG. 7 includes a drive device 1000, an auxiliary storage device 1002, a memory device 1003, a CPU 1004, an interface device 1005, a display device 1006, an input device 1007, an output device 1008, and the like, which are connected to each other by a bus BS.

A program for realizing processing in the computer is provided by, for example, a recording medium 1001 such as a CD-ROM or a memory card. When the recording medium 1001 having the program stored therein is set in the drive device 1000, the program is installed in the auxiliary storage device 1002 from the recording medium 1001 via the drive device 1000. However, the program does not necessarily have to be installed from the recording medium 1001, and may be downloaded from another computer via a network. The auxiliary storage device 1002 stores the installed program and also stores necessary files, data, and the like.

The memory device 1003 reads and stores the program from the auxiliary storage device 1002 when there is an instruction to start the program. The CPU 1004 realizes functions related to the device according to a program stored in the memory device 1003. The interface device 1005 is used as an interface for connection to a network and functions as a transmission unit and reception unit. The display device 1006 displays a graphical user interface (GUI) or the like according to a program. The input device 1007 is configured of a keyboard, a mouse, buttons, a touch panel, or the like, and is used to input various operation instructions. The output device 1008 outputs a calculation result.

### Operation Flow

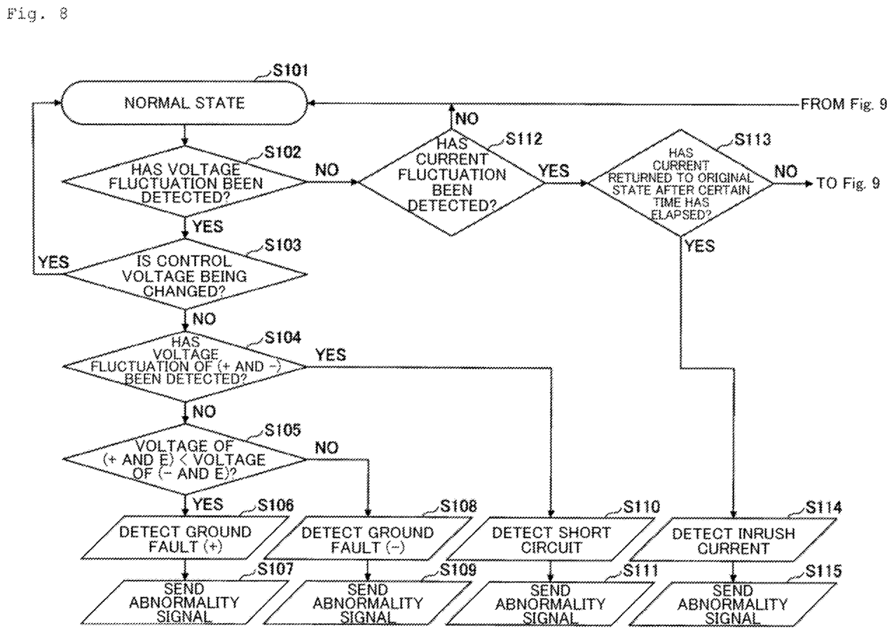

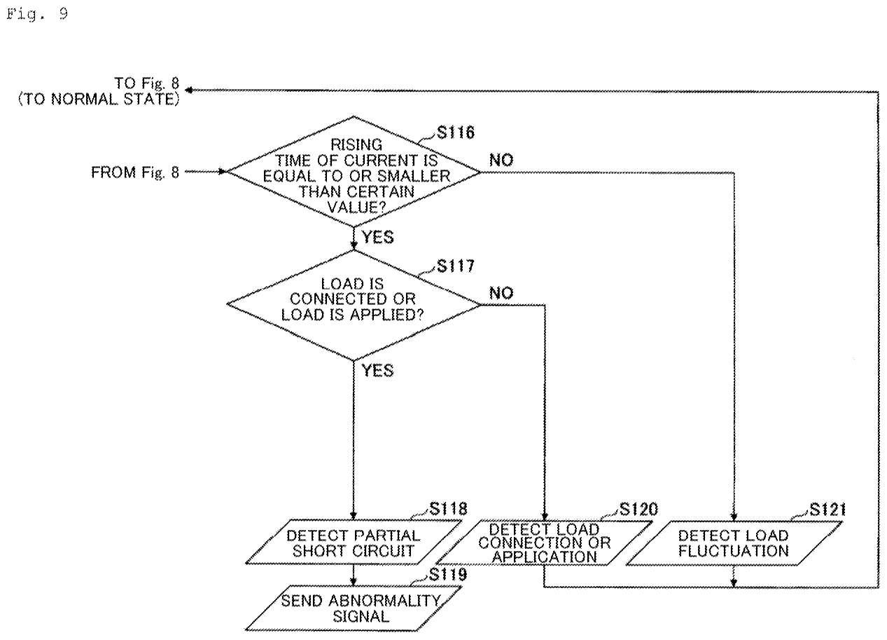

Next, a detailed operation example of the control device 100A will be described with reference to the flowcharts of FIGS. 8 and 9. An operation illustrated in the flowcharts of FIGS. 8 and 9 is an operation that executed by the determination unit 120 of the control device 100A. Further, monitoring targets assumed in the flowcharts of FIGS. 8 and 9 are V1 that is a voltage between the positive side power distribution line and the neutral point (earth), V2 that is a voltage between the negative side power distribution line and the neutral point (earth), V1+V2=V that is a voltage between the positive side power distribution line and the negative side power distribution line, and a current flowing through the power distribution line (for example, a current measured by the ammeter 7 illustrated in FIG. 1).

In S101, because the determination unit 120 does not detect fluctuation in any of V1, V2, V, and the current, the direct-current power distribution system is in a normal state.

In S102, the determination unit 120 determines whether or not the fluctuation in the voltage (V1, V2, or V) has been detected, and proceeds to S103 when the fluctuation has been detected and to S112 when the fluctuation has not been detected. “Detecting the fluctuation in voltage” is to detect, for example, that a value of the voltage at time t+Δt has changed above a threshold value as compared to a value of a voltage at time t. The same applies to “detecting fluctuation in current”.

When the voltage fluctuation has been detected (Yes in S102), the determination unit 120 determines in S103 whether or not a control voltage is being changed on the basis of information on a state of the converter A 20. When a floating charging storage battery is connected to the direct-current power distribution system that is a target, it is determined whether or not “(the control voltage is being changed) and (a storage battery is not being discharged)” in the determination in S103. The processing returns to S101 when the determination in S103 is Yes, and proceeds to S104 when the determination in S103 is No.

The determination unit 120 proceeds to S110 when the detected voltage fluctuation is fluctuation in V (=V1+V2) in S104, and to S105 when the detected voltage fluctuation is not the fluctuation in V (=V1+V2).

In S105, the determination unit 120 determines whether or not “V1<V2”, and proceeds to S106 when “V1<V2” and to S108 when “V1<V2” is not satisfied.

In S106 when “V1<V2”, the detection unit 120 determines that a ground fault has occurred in the positive side power distribution line. Because the positive side power distribution line is grounded via a ground fault resistor (having a low resistance) when the ground fault has occurred in the positive side power distribution line, a voltage across the resistor 1 on the positive side drops, a voltage across the resistor 2 on the negative side rises, and “V1<V2”. In S107, the control unit 140, which has received a notification of ground fault detection from the determination unit 120, sends an abnormality signal.

When the determination in S105 is No, that is, when “V1<V2” is not satisfied, the detection unit 120 determines that a ground fault has occurred in the negative side power distribution line in S108. Because the negative side power distribution line is grounded via the ground fault resistor (having a low resistance) when the ground fault has occurred in the negative side power distribution line, the voltage across the resistor 2 on the negative side drops, the voltage across the resistor 1 on the positive side rises, and “V1>V2”. In S109, the control unit 140, which has received the notification of ground fault detection from the determination unit 120, sends an abnormality signal.

When the determination in S104 is Yes, that is, when the fluctuation in V is detected, the determination unit 120 determines in S110 that the short circuit has occurred. In S111, the control unit 140, which has received the notification of ground fault detection from the determination unit 120, sends an abnormality signal.

When the determination in S102 is No (that is, when the voltage fluctuation is not detected), the determination unit 120 determines in S112 whether or not there is a current fluctuation, and proceeds to S113 when there is a current fluctuation.

In S113, the determination unit 120 determines whether or not the current value has returned to a value before fluctuation after a predetermined time has elapsed since the current fluctuates. When the determination result is No, the processing returns to S101. When the determination result is Yes, the determination unit 120 proceeds to S114, and the determination unit 120 determines that an inrush current has occurred. In S115, the control unit 140, which has received the notification of the inrush current detection from the determination unit 120, sends an abnormality signal. The inrush current may be regarded as being in a normal state and the abnormality signal may not be transmitted.

When the determination in S113 is No, that is, when the current has not returned to an original value after a certain time has elapsed, the determination unit 120 proceeds to S116 in FIG. 9.

In S116, the determination unit 120 determines whether or not a rising time of the current is equal to or smaller than a threshold value. When the determination unit 120 determines that the rising time of the current is equal to or smaller than the threshold value, the determination unit 120 proceeds to S117.

In S117, the determination unit 120 determines whether or not a load is connected or the load is applied at a current rising time, on the basis of the device information received from the base B.

When the determination result in S117 is No, the determination unit 120 determines in S118 that a partial short circuit has occurred. In S119, the control unit 140, which has received a notification of partial short circuit detection from the determination unit 120, sends an abnormality signal.

When the determination in S117 is Yes, that is, when the load is connected or the load is applied, the determination unit 120 proceeds to S119, the determination unit 120 determines that the load is connected or the load is applied, and the processing returns to S101.

When the determination in S116 is No, that is, when the rising time of the current is not equal to or smaller than the threshold value, the determination unit 120 proceeds to S120 and the determination unit 120 determines that the load has fluctuated and returns to S101.

### Determination Based on Waveform

In a determination of each event illustrated in FIG. 9, in greater detail, the determination unit 120 performs a determination on the basis of a waveform corresponding to the event. The “waveform” used in the determination may be the waveform itself (that is, a value in each time), or a feature amount such as an inclination (differential) and a change time length may be used as the “waveform”.

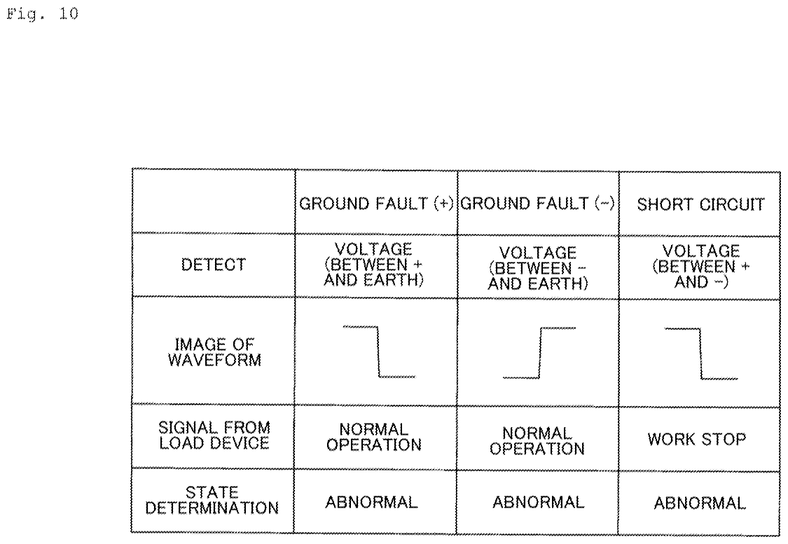

FIG. 10 is a diagram illustrating an image of respective waveforms corresponding to a ground fault (+), a ground fault (−), and a short circuit in the case of Yes in S102 (a case in which there is a voltage fluctuation) in the flow of FIG. 8.

As illustrated in FIG. 10, it can be determined that the ground fault (+) has occurred when a waveform in which a potential of the positive side power distribution line suddenly decreases and approaches 0 V has been detected between the positive side power distribution line and the earth. Further, it can be determined that a ground fault (−) has occurred when a waveform in which a potential of the negative side power distribution line suddenly increases and approaches 0 V has been detected between the negative side power distribution line and the earth. In the determination in S105 of FIG. 8, it may be determined whether or not the change in voltage corresponds to a waveform having such characteristics.

Further, when a waveform in which the voltage between the positive side power distribution line and the negative side power distribution line suddenly decreases has been detected, it can be determined that a short circuit has occurred.

FIG. 10 illustrates a signal from the load device when each event has occurred. When it is found that the load device is operating normally in the “ground fault (+)” and the “ground fault (−)”, it is possible to more accurately determine that voltage fluctuation is caused by the ground fault.

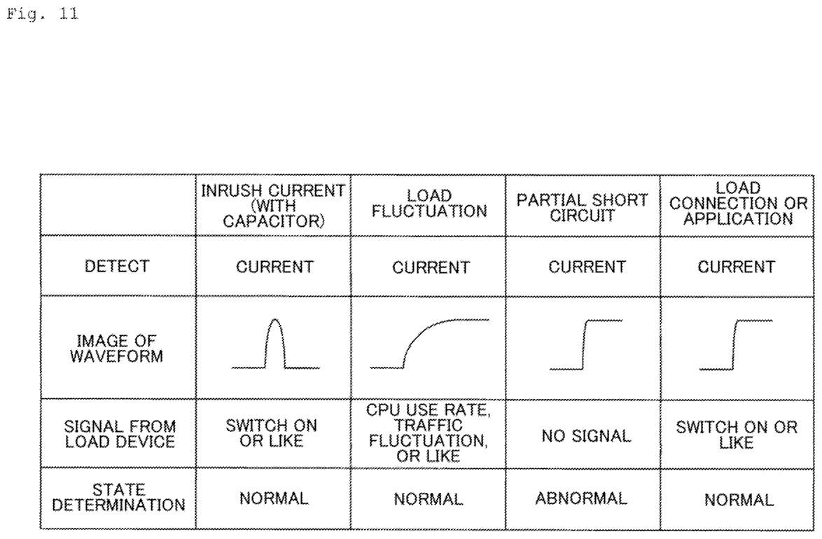

FIG. 11 illustrates a diagram illustrating images of respective waveforms corresponding to an inrush current, a load fluctuation, a partial short circuit, and a load connection or load application when there is a voltage fluctuation in the case of No in S102 in the flow of FIG. 8 (when there is no voltage fluctuation).

As illustrated in FIG. 11, a waveform of a current in a case in which the inrush current has been generated becomes a waveform in which the value of the current rises and immediately returns to an original value. S113 in FIG. 8 corresponds to determining whether or not change in value of the measured current corresponds to a waveform having such characteristics.

A waveform of a current in a case in which the load fluctuation has occurred is a waveform in which the value of the current gradually increases and does not immediately return to an original value. S116 in FIG. 9 corresponds to determining whether or not change in value of the measured current corresponds to a waveform having such characteristics.

The waveforms in the partial short circuit and the load connection or application are similar to each other, and are waveforms in which the current suddenly increases. However, in the case of the partial short circuit, a special signal (switch ON or the like) is not obtained from the load device, and in the case of the load connection or application, a signal such as switch ON is obtained from the load device. That is, the partial short circuit and the load connection or application can be identified by the waveform and the device information. S116 and S117 in FIG. 9 correspond to the determination based on the waveform and the device information.

### Effects of Embodiment

As described above, with the technology according to the present embodiment, it is possible to avoid erroneously determining an event such as a load fluctuation to be an accident and accurately detect an accident that has occurred in a direct-current power distribution system.

### Conclusion of Embodiment

The present specification discloses at least a direct-current power distribution system, a control device, an operating state determination method, and a program of the following items.

### Item 1

A direct-current power distribution system for distributing power from a power supply device to a load device via a power distribution network, the direct-current power distribution system including:

a measuring instrument included in the power distribution network; and

a control device including a determination unit configured to acquire a voltage value and a current value measured by the measuring instrument, and determine an operating state in the direct-current power distribution system on the basis of a waveform indicating change in the voltage value and a waveform indicating change in the current value,

### Item 2

The direct-current power distribution system according to item 1, wherein the control device includes

a control unit configured to stop power distribution from the power supply device by operating a gate block included in the power supply device when the determination unit determines that an accident has occurred in the power distribution network,

### Item 3

The direct-current power distribution system according to item 2, wherein the determination unit calculates impedance from the voltage value and the current value acquired by the measuring instrument, and estimates a distance from the measuring instrument to an accident point on the basis of the impedance,

### Item 4

The direct-current power distribution system according to any one of items 1 to 3, wherein the determination unit identifies whether a partial short circuit has occurred or whether a load connection or load application has occurred, on the basis of the waveform indicating change in the current value and device information obtained from the load device,

### Item 5

The direct-current power distribution system according to any one of items 1 to 4, further including a learning device configured to learn a model that outputs an operating state corresponding to an input waveform on the basis of an operating state in the direct-current power distribution system and a waveform of a voltage value or a current value corresponding to the operating state,

### Item 6

An operating state determination method in a direct-current power distribution system for distributing power from a power supply device to a load device via a power distribution network, the operating state determination method including: a step of measuring, by a measuring instrument included in the power distribution network, a voltage value and a current value; and

a step of acquiring the voltage value and the current value measured by the measuring instrument, and determining an operating state in the direct-current power distribution system on the basis of a waveform indicating change in the voltage value and a waveform indicating change in the current value,

### Item 7

A control device used in a direct-current power distribution system for distributing power from a power supply device to a load device via a power distribution network, the control device including:

a determination unit configured to acquire a voltage value and a current value measured by a measuring instrument included in the power distribution network, and determine an operating state in the direct-current power distribution system on the basis of a waveform indicating change in the voltage value and a waveform indicating change in the current value,

### Item 8

A program for causing a computer to function as the control device according to item V.

Although the embodiment has been described above, the present invention is not limited to such a specific embodiment, and various modifications and changes can be made within the scope of the gist of the present invention described in the claims.

### REFERENCE SIGNS LIST

1, 2, 1, 42 Resistor
3, 4, 9, 43, 44, 49 Voltmeter
6, 7, 8, 10, 46, 47, 48, 50 Ammeter
20, 30, 70 Converter
100 Control device
110 Monitoring unit
120 Determination unit
130 Communication unit
140 Control unit
150 Storage unit
160 Display unit
200 Learning device
210 Learning unit
220 Storage unit
230 Communication unit
80 Load device
1000 Drive unit
1001 Recording medium
1002 Auxiliary storage device
1003 Memory device
1004 CPU
1005 Interface device
1006 Display device
1007 Input device

1. A direct-current power distribution system for distributing power from a power supply to a load device via a power distribution network, the direct-current power distribution system comprising:
a measuring instrument included in the power distribution network, the measuring instrument being configured to measure (i) a magnitude of a voltage that is supplied to the power distribution network and (ii) a magnitude of a current that flows into the power distribution network; and
a control device including processing circuitry, the processing circuitry being configured to
acquire the voltage magnitude and the current magnitude that are measured by the measuring instrument, and
determine an operating state in the direct-current power distribution system, based on a first waveform indicating a change in the voltage magnitude and a second waveform indicating a change in the current magnitude.

2. The direct-current power distribution system according to claim 1, wherein the processing circuitry of the control device is configured to
determine whether a fault occurs in the power distribution network, and
enable a gate block included in the power supply device, upon determining the fault has occurred in the power distribution network, to interrupt power distribution through the power supply.

3. The direct-current power distribution system according to claim 2, wherein the processing circuitry is configured to
determine impedance based on the voltage magnitude and the current magnitude acquired by the measuring instrument, and
estimate a distance from the measuring instrument to a point of the fault, based on the determined impedance.

4. The direct-current power distribution system according to claim 1, wherein the processing circuitry is configured to
determine whether
(i) a partial short circuit has occurred, or
(ii) a connection to a load has been established, or
(iii) an application of the load has occurred, based on the second waveform and device information that is obtained from the load device.

5. The direct-current power distribution system according to claim 1, further comprising a learning device, the learning device including second processing circuitry configured to
receive a given waveform, and
learn, based on (i) an operating state in the direct-current power distribution system and (ii) the first waveform or the second waveform corresponding the operating state, a model that outputs an operating state corresponding to the received given waveform.

6. A method for determining an operating state in a direct-current power distribution system that distributes power from a power supply to a load device via a power distribution network, the method comprising:
measuring, by a measuring instrument included in the power distribution network, (i) a magnitude of a voltage that is supplied to the power distribution network and (ii) a magnitude of a current that flows into the power distribution network;
acquiring the voltage magnitude and the current magnitude that are measured by the measuring instrument; and
determining an operating state in the direct-current power distribution system, based on a waveform indicating a change in the voltage magnitude and a waveform indicating a change in the current magnitude.

7. A control device configured to be used in a direct-current power distribution system that is configured to distribute power from a power supply to a load device via a power distribution network, the control device comprising:
processing circuitry configured to
acquire (i) a magnitude of a voltage that is supplied to the power distribution network and (ii) a magnitude of a current that flows into the power distribution network, the magnitude of the voltage and the magnitude of the current being measured by a measuring instrument that is included in the power distribution network, and
determine an operating state in the direct-current power distribution system, based on a waveform indicating a change in the voltage magnitude and a waveform indicating a change in the current magnitude.

8. (canceled)
